(19) United States
(12) Patent Application Publication
(10) Pub. No.: US 2010/0296371 A1
(43) Pub. Date: Nov. 25, 2010

(54) Rotative clock

(76) Inventor: Tey-Jen Wu, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/453,708

(22) Filed: May 20, 2009

(51) Int. Cl. G04C 17/00

(52) U.S. Cl. 368/242

(57) ABSTRACT

In a rotative desk clock having in a main body of it a clock module, a driving module and a control module for sound controlling or touch controlling, wherein the driving module includes a rotary disk exposed downwardly out of the main body, when the control module is touched by a hand or senses the change of sound waves, it activates the driving module to rotate a rotary disk; thereby if the rotary disk is placed on the desk, the main body can rotate relatively to the rotary disk. Thus a dynamically rotating clock is formed.

### BACKGROUND OF THE INVENTION

1. Field of the Invention

The present invention relates to a device concerning a rotative desk clock, and especially to a desk clock able to be rotated.

2. Description of the Prior Art

A clock is a necessary daily used article in modern life; clocks normally sold to be hung on walls have appearances out of many inventive designs, while for those desk clocks placed on desks, there are few inventive designs, generally, bases of desk clocks are directly stand dumbly on desks or bed-side cupboards without any unique variation.

FIG. 1 shows a desk 1 of which a top is provided thereon with a conventional desk clock 2, the appearance of the desk clock 2 is rectangular, and the desk clock 2 is provided on one side thereof with a display unit 3 to show time, the desk clock 2 further is provided with a plurality of control keys 4 for the convenience of doing various setting works by a consumer; by virtue that the desk clock 2 is not provided with any structure for variation, it can only be placed directly on the top of the desk 1 and stands dumbly thereon; people who follow the tide of asking for beauty in house designs and for life taste, prefer that the desk clocks on the desks are redesigned for consumers to increase the taste of them.

In addition to this, showing of a light source in the desk clock 2 on a desk can only be given when the control keys 4 are pressed down, such design can only allow reading the number of time showing on the display unit 3 during midnight or insufficiency of light after the control keys 4 of the desk clock 2 are found through searching in the dark and then the control keys 4 are pressed down to activate the light. This makes a big trouble in using, especially during half waking up of one who has to interrupt sleeping for searching in the dark the control keys 4.

To solve the above stated problem of the prior art, the inventor of the present invention provides a “rotative clock” able to rotate and emit light upon the spot to not only have increased taste in use, but also has the effects of quite large convenience for operation, and easiness for use.

### SUMMARY OF THE INVENTION

The object of the present invention is to provide a “rotative clock”, the clock can be rotated or have its sound controlled to have increased taste in use when it is rotated upon the spot by slightly touching of a hand, and when light illumination is inferior, a light source built in the clock can emit light by such sound control or hand touching, and various displayed contents on a time module can be seen clearly, thus convenience of use can be achieved.

Therefore, in order to get the above object, the “rotative clock” of the present invention can be provided in a main body of it with a clock module, a driving module and a control module for sound controlling or touch controlling. Wherein:

The main body is composed of an upper and a lower shell which combine with each other to get an appearance like a circular sphere, the upper shell has an appearance of a semi-sphere having therein a receiving space and being cut to form a viewing window; the lower shell also has an appearance of a semi-sphere having therein a receiving space and being cut to form hole.

The clock module is provided in the receiving space of the upper shell; it has a liquid crystal display unit for viewing time, temperature or time counting through the viewing window, a circuit unit for controlling the liquid crystal display, and has a setting unit to electrically connect the circuit unit; the setting unit can be used to adjust and set the displayed content of the liquid crystal display unit; the above mentioned driving module is provided in the lower shell, and includes a motor fixed in the lower shell, a rotary disk connected with the motor, the rotary disk extends through the hole and exposed downwardly out of the lower shell and capable of being placed on the desk.

The above mentioned control module includes a control circuit provided in the upper shell, the control circuit is electrically connected with the driving module, when in practicing, the control circuit can be an electric resistance type or an electric capacitance type touch sensitive circuit, and the control circuit includes a transparent glue layer electrically connected with the control circuit, the transparent glue layer envelops the outer sides of the upper and the lower shells; when the transparent glue layer is touched, the control circuit senses the change of electric resistance or electric capacitance of the transparent glue layer to activate the motor of the driving module to rotate, by virtue that the motor is fixed in the lower shell and connected with the rotary disk exposed downwardly out of the lower shell, when the motor drives the rotary disk, and the rotary disk is placed on the desk, the whole clock can rotate relatively to the rotary disk.

And more, in practicing, the control circuit of the control module can be a sound controlling circuit, when the control circuit senses the change of sound waves, it activates the motor of the driving module to rotate the rotary disk, this can likewise get the object of rotation of the clock relatively to the rotary disk as stated above, i.e., the “rotative clock” of the present invention can be rotated upon the spot or have its sound control led by slightly touching of a hand to have increased taste in use.

In comparison with the conventional desk clock which is inconvenient for use, the “rotative clock” of the present invention can rotate by itself and has an effect of increasing taste in use, and when light illumination is inferior, light emitting modules provided in the upper and the lower shell can emit light by sound controlling or touch controlling, so that one can clearly see various displayed contents on a time module, thus convenience of use can be achieved.

The present invention will be apparent in its technical measures after reading the detailed description of the preferred embodiment thereof in reference to the accompanying drawings.

### BRIEF DESCRIPTION OF THE DRAWINGS

FIG. 1 is a perspective schematic view of a conventional desk clock placed on a table;

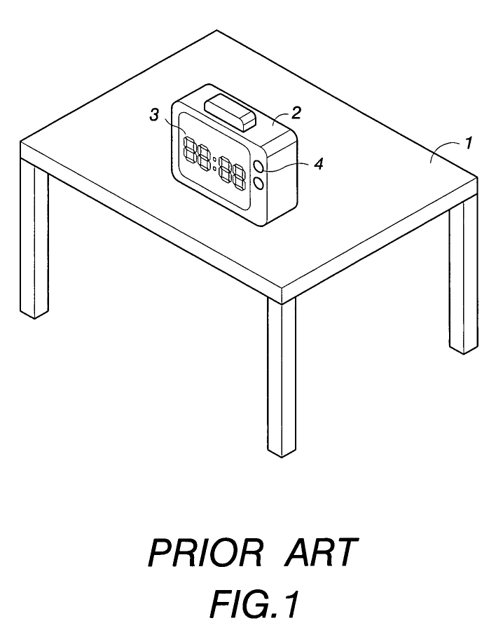

FIG. 2 is a perspective view showing the appearance of a rotative clock of the present invention;

FIG. 3 is an anatomic perspective view showing the appearance of the rotative clock of the present invention;

FIG. 4 is a perspective schematic view showing an upper and a lower shell of the present invention;

FIG. 5 is a schematic sectional view of the rotative clock of the present invention;

FIG. 6 is a bottom view of the rotative clock of the present invention.

### DETAILED DESCRIPTION OF THE PREFERRED EMBODIMENT

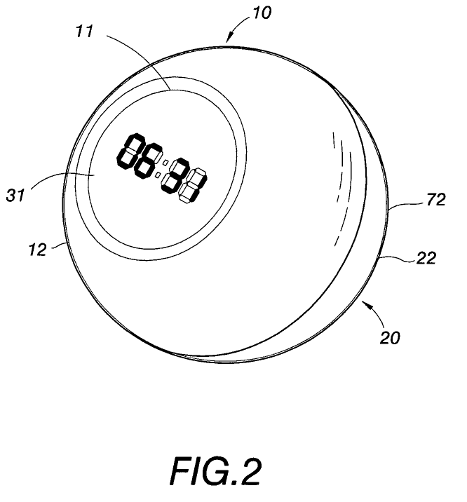

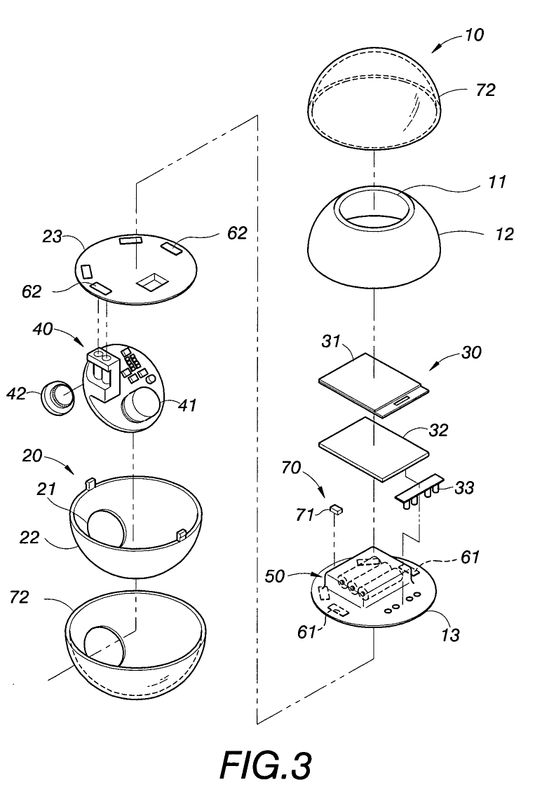

Referring to FIGS. 2 and 3, the “rotative clock” of the present invention is composed of an upper shell 10 and a lower shell 20 which combine with each other to get an appearance like a circular sphere, the upper and the lower shells 10, 20 each has an appearance of a semi-sphere having therein a receiving space to respectively receive a clock module 30, a driving module 40, an electric power supply 50 and a plurality of upper and lower electric conductive sheets 61, 62 for electric connecting of the upper and the lower shells 10, 20, and a control module 70 capable of activating the driving module 40. Wherein:

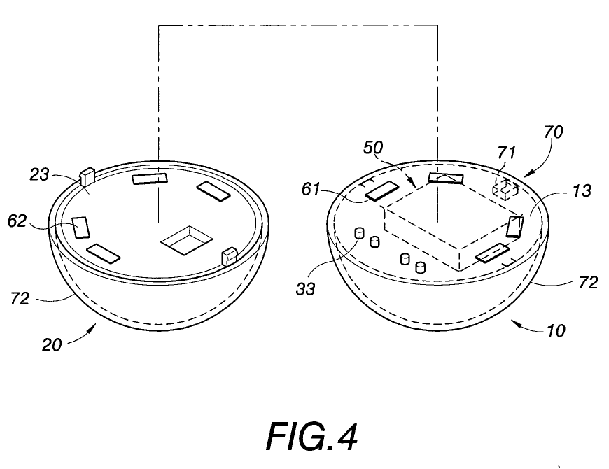

The upper shell 10 (referring to FIG. 4) has an appearance of a semi-sphere which is composed of a semi-circular shell 12 being cut to form a viewing window 11 and an upper plain plate 13, and having therein a receiving space; The lower shell 20 also has an appearance of a semi-sphere which is composed of a lower semi-circular shell 22 being cut to form a hole 21 and a lower plain plate 23, and also having therein a receiving space.

The clock module 30 is provided in the receiving space of the upper shell 10; it has a liquid crystal display unit 31 for viewing time, temperature or time counting through the viewing window 11, and has an circuit unit 32 adapted for controlling the displayed content of a liquid crystal display 31, more over, the clock module 30 further has a setting unit 33 which is electrically connected with the circuit unit 32 for adjusting and setting the content to be displayed by the liquid crystal display 31; in practicing, the setting unit 33 can have a plurality of push buttons protruding out of the plain plate 13 for operating.

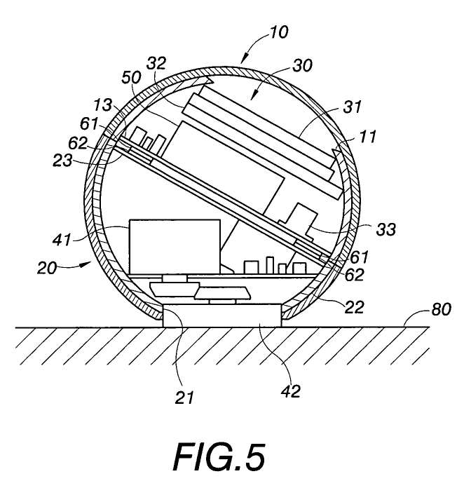

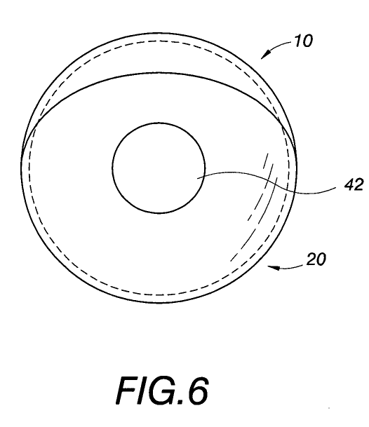

As shown in FIGS. 3 to 5, the above mentioned driving module 40 is provided in a receiving space of the lower shell 20, it includes a motor 41 fixed in the lower semi-circular shell 22, a rotary disk 42 connected with the motor 41; and referring simultaneously to FIG. 6, the rotary disk 42 extends through the hole 21 and exposed downwardly out of the lower shell 20 and capable of being placed on a desk 80.

As shown in FIGS. 3-5, the above mentioned electric power supply 50 is provided in a receiving space of the upper shell 10 and is electrically connected with the clock module 30 to provide electric power for operation of the clock module 30; the above mentioned upper electric conductive sheets 61 are provided on the upper plain plate 13 of the upper shell 10, the upper electric conductive sheets 61 are electrically connected with the electric power supply 50; the lower electric conductive sheets 62 are provided on the lower plain plate 23 of the lower shell 20, it is located in opposition to the upper electric conductive sheets 61 and is electrically connected with the driving module 40, hence when the upper and the lower shells 10, 20 are assembled with each other, the upper and the lower electric conductive sheets 61, 62 are electric connected mutually, so that the electric power supply 50 in the upper shell 10 can provide electric power for the driving module 40 in the lower shell 20 for operation.

The above mentioned control module 70 includes a control circuit 71 provided in the upper shell 10, the control circuit 71 is electrically connected with the driving module 40; when in practicing, the control circuit 71 can be an electric resistance type or an electric capacitance type touch sensitive circuit, and the control circuit 71 includes a transparent glue layer 72 electrically connected with the control circuit 71, the transparent glue layer 72 envelops the outer sides of the upper and the lower shells 10, 20; when the transparent glue layer 72 is touched, the control circuit 71 senses the change of electric resistance or electric capacitance of the transparent glue layer 72 to activate the motor 41 of the driving module 40 to rotate, by virtue that the motor 41 is fixed in the lower shell 20 and connected with the rotary disk 42 exposed downwardly out of the lower shell 20, when the motor 41 drives the rotary disk 42 which is placed on the desk 80, the whole clock can be rotated relatively to the rotary disk 42.

And more, in practicing, the control circuit 71 of the control module 70 can be a sound controlling circuit, when the control circuit 71 senses the change of soundwaves, it activates the motor 41 of the driving module 40 to rotate the rotary disk 42, this can likewise get the object of rotation of the clock relatively to the rotary disk 42 as stated above, i.e., the “rotative clock” of the present invention can be rotated upon the spot or have its sound controlled by slight touching of a hand to have increased taste in use.

And in practicing, the receiving spaces of the upper and the lower shells 10, 20 can be provided with light emitting modules which are electrically connected with the electric power supply 50 and the control module 70; when the control circuit 71 of the control module 70 senses the change of sound waves or senses the change of electric resistance or electric capacitance of the transparent glue layer 72, it activates the light emitting modules to provide light illumination and to increase taste for consumers in use.

In addition to these, in order to increase taste in use, the appearance of a sphere composed of the upper and the lower shells 10, 20 can be a terrestrial globe in practice, or can be any of some other appearances including a basketball, a saucer ball, a volley ball and a base ball etc., for the purpose of increasing tastes.

The names of the members and the drawings for the present invention are only for illustrating preferred embodiments of the present invention, and not for giving any limitation to the scope of the present invention. It will be apparent to those skilled in this art that various equivalent modifications or changes without departing from the spirit, scope of this invention shall fall within the scope of the appended claims and are intended to form part of this invention.

1. A “rotative clock” being provided in a main body of it with a clock module, a driving module and a control module for activating said driving module, wherein:
said main body is provided with a viewing window and a hole; said clock module has a liquid crystal display unit, has a circuit unit for controlling the liquid crystal display, and has a setting unit to electrically connect said circuit unit;
said driving module includes a motor fixed in said main body, a rotary disk connected with said motor, said rotary disk extends through said hole and exposed downwardly out of said main body and capable of being placed on a desk;
said control module includes a control circuit, said control circuit is electrically connected with said driving module, said control circuit activates said motor of said driving module to rotate said main body relatively to said rotary disk, thereby said clock forms a dynamically rotating clock.

2. The “rotative clock” as in claim 1, wherein: said main body is composed of an upper and a lower shell both are semi-spherical which combine with each other to get an appearance as a circular sphere, said upper shell has said viewing window, and receives said clock module and said control module, and has on its bottom an upper plain plate; said lower shell receives said driving module and has said hole, and is provided thereabove with a lower plain plate in opposition to said upper plain plate.

3. The “rotative clock” as in claim 2, wherein: said upper shell further is provided therein with an electric power supply for operation of said clock module, said upper plain plate further is provided with a plurality of upper electric conductive sheets electrically connected with said electric power supply; said lower plain plate is provided with a plurality of lower electric conductive sheets in opposition to said upper electric conductive sheets and electrically connected with said driving module, said electric power supply provides electric power for said driving module by contacting of said upper electric conductive sheets with said lower electric conductive sheets.

4. The “rotative clock” as in claim 3, wherein: said setting unit has a plurality of push buttons provided on said upper plain plate.

5. The “rotative clock” as in claim 2, wherein: said circular sphere formed by combining of said upper shell with said lower shell has an appearance of a terrestrial globe, or any of some other balls.

6. The “rotative clock” as in claim 1, wherein: said main body further is provided with a plurality of light emitting modules which are electrically connected with said control circuit of said control module.

7. The “rotative clock” as in claim 1, wherein: said control circuit is a touch sensitive circuit, and said control circuit includes a transparent glue layer electrically connected with said control circuit, said transparent glue layer envelops outer sides of said upper and said lower shells; when said transparent glue layer is touched, said control circuit is activated to operate.

8. The “rotative clock” as in claim 1, wherein: said control circuit is a sound controlling circuit, when said control circuit senses change of sound waves, it activates said control circuit to operate.
